(19) United States
(12) Patent Application Publication
(10) Pub. No.: US 2007/0014279 A1
(43) Pub. Date: Jan. 18, 2007

(54) Residential ethernet switching device for sub frame-based switching

(75) Inventors: Si Hai Wang, Suwon-si (KR); Kwan-Soo Lee, Seoul (KR); Yun-Je Oh, Yongin-si (KR); Jun-Ho Koh, Suwon-si (KR); Sang-Ho Kim, Hwaseong-si (KR); Jae-Hun Cho, Seoul (KR)

Correspondence Address: CHA & REITER, LLC, 210 ROUTE 4 EAST STE 103, PARAMUS, NJ, 07652, US

(73) Assignee: Samsung Electronics Co.; LTD

(21) Appl. No.: 11/481,588

(22) Filed: Jul. 6, 2006

(30) Foreign Application Priority Data
Jul. 16, 2005 (KR) 2005-64592

(51) Int. Cl. H04L 12/28; H04L 12/56

(52) U.S. Cl. 370/351; 370/412

(57) ABSTRACT

A residential Ethernet switching device for sub frame-based switching in a residential Ethernet system is provided. The device includes a plurality of reception data path processors for parsing a residential Ethernet frame inputted to the residential Ethernet switching device, as respective residential Ethernet sub frames, and outputting the parsed residential Ethernet sub frames, a switch fabric for switching the residential Ethernet sub frames inputted through the plurality of reception data path processors, a plurality of transmission data path processors for providing an output path for multiplexing and outputting the residential Ethernet sub frames switched through the switch fabric, and a local cycle counter connected to the plurality of reception data path processors, the switch fabric, and the plurality of transmission data path processors, and providing cycle counter information on the respective residential Ethernet sub-frames.

### CLAIM OF PRIORITY

This application claims the benefit of the earlier filing date, pursuant to 35 U.S.C. § 119, to that patent application entitled “Residential Ethernet Switching Device For Sub frame-based switching” filed in the Korean Intellectual Property Office on Jul. 16, 2005 and assigned Serial No. 2005-64592, the contents of which are incorporated herein by reference.

### BACKGROUND OF THE INVENTION

1. Field of the Invention

The present invention relates generally to a residential Ethernet system, and in particular, to a residential Ethernet switching device for sub frame-based switching.

2. Description of the Related Art

Ethernet protocol is the most widely constructed local-area network (LAN) technique. Although the Ethernet is currently defined in the Institute of Electrical and Electronics Engineers (IEEE) 802.3 standard, it was originally developed by Xerox Corporation, and has been developed by Xerox Corporation, DEC Corporation, and Intel Corporation among other companies. The Ethernet is the most popular technique used for transmitting data between different terminals or users.

The Ethernet protocol allows for competitive access using carrier sense multiple access/collision detect (CSMA/CD) protocol that is standardized in the IEEE 802.3, and is one of most universal and familiar technologies for data transmission between terminals different from each other or between several users. In a conventional Ethernet, the upper layer service frames are converted into Ethernet frames to be transmitted while maintaining an inter-frame gap (IFG). Thus, the upper layer service frames are transmitted in a frame occurrence sequence regardless of the type of the upper-layer service frames.

The Ethernet, which is based on a CSMA/CD transmission method wherein the Ethernet frames are competitively transmitted with the same priority, is known as a technology unsuitable to moving picture or voice transmission sensitive to transmission time delay.

In recent years, many attempts and theories of the moving picture and/or voice transmission have been proposed. However, such proposals can only be applied to real-time application programs of poor and low qualities due to in-born limit of performance of the Ethernet.

In pursuit of the development of digital media such as MP3 music, online video, digital image, and digital TV, Ethernet development for supporting the real-time application programs are being required with acuteness.

One method for such real-time communication, referred to as residential Ethernet, has been proposed.

In residential Ethernet a cycle is based on a 125 μsec a unit of transmission, which is divided into a synchronous data transmission duration and an asynchronous data transmission duration. Synchronous data transmission duration is given priority, over asynchronous data transmission, thereby guaranteeing a quality of service (QoS).

FIG. 1 is a diagram illustrating an example of a transmission cycle in a conventional residential Ethernet.

As shown in FIG. 1, in the conventional residential Ethernet a data transmission cycle (10) is based on a 125 μsec frame or cycle. Each cycle includes asynchronous frame duration 110 for transmitting asynchronous data, and synchronous frame duration 100 for transmitting synchronous data.

In a more detail description, the synchronous frame duration 100 is a duration having the largest priority in the transmission cycle. The synchronous frame duration 100 includes sub-synchronous frames 101, 102, and 103, each of which is based on 738 bytes, respectively, according to a scheme under discussion. Although 738 bytes is currently being discussed, it would be recognized that the number of bytes can be modified without altering the scope of the invention.

The asynchronous frame duration 110 includes sub-asynchronous frames 111, 112, and 113 having variable sizes in its regions.

In the residential Ethernet, a maximum delay of 250 μsec in transmission of synchronous data packets between nodes is imposed. In other words, after one-frame of synchronous data is transmitted at a predetermined node, a next synchronous data should be transmitted within 250 μsec, thereby guaranteeing a quality of service (QoS) of the synchronous data.

The 250 μsec delay limit becomes more critical in comparison to a general legacy Ethernet. In order to keep the delay in the residential Ethernet transmission node, admission control is used. However, it is impossible to sufficiently keep the delay of 250 μsec, using only the admission control. The reason is that the admission control can be used after a uniform control of time between respective nodes is enabled. However, in a conventional residential Ethernet system, a timing control method for the respective nodes has not been proposed and thus, QoS cannot be sufficiently satisfied in real-time data transmission.

### SUMMARY OF THE INVENTION

The present invention provides a residential Ethernet switching device based on a sub-frame, for guaranteeing a delay limit of real-time data transmission for each transmission node of residential Ethernet.

In one embodiment, there is provided a residential Ethernet switching device for sub-frame-based switching in a residential Ethernet system for distinguishing and transmitting isochronous data and asynchronous data. The device includes a plurality of reception data path processors for parsing a residential Ethernet frame inputted to the residential Ethernet switching device, as respective residential Ethernet sub frames, and receiving the parsed residential Ethernet sub frames, a switch fabric for switching the residential Ethernet sub-frames inputted through the plurality of reception data path processors; a plurality of transmission data path processors for providing an output path for multiplexing and outputting the residential Ethernet sub-frames switched through the switch fabric, and a local cycle counter connected to the plurality of reception data path processors, the switch fabric, and the plurality of transmission data path processors, and providing cycle counter information on the respective residential Ethernet sub-frames.

### BRIEF DESCRIPTION OF THE DRAWINGS

The above features and advantages of the present invention will become more apparent from the following detailed description when taken in conjunction with the accompanying drawings in which:

FIG. 1 is a diagram illustrating a transmission cycle in a conventional residential Ethernet;

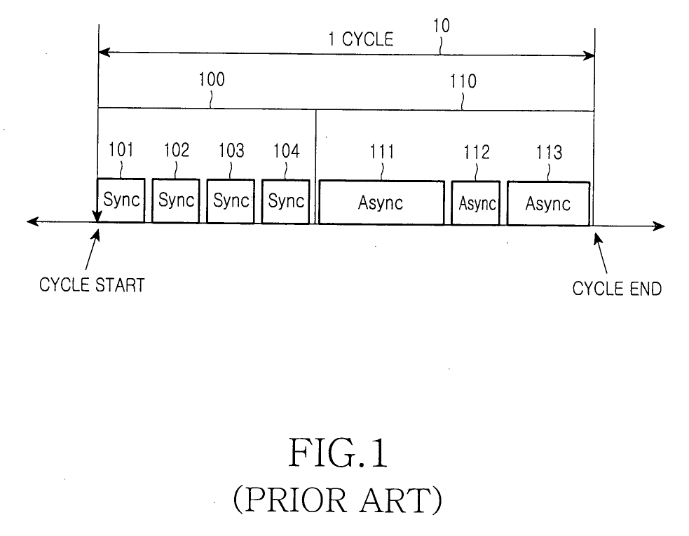

FIG. 2 illustrates a transmission cycle in a residential Ethernet according to an exemplary embodiment of the present invention;

FIG. 3 illustrates a sub-frame in a residential Ethernet according to an exemplary embodiment of the present invention;

FIG. 4 illustrates construction of a residential Ethernet switching device according to an exemplary embodiment of the present invention; and

FIG. 5 is a detailed view illustrating a construction of a transmission data path processor in a residential Ethernet switching device according to the present invention.

### DETAILED DESCRIPTION OF THE INVENTION

Embodiments of the present invention will now be described in detail with reference to the annexed drawings. In the drawings, the same or similar elements are denoted by the same reference numerals even though they are depicted in different drawings. For the purposes of clarity and simplicity, a detailed description of known functions and configurations incorporated herein has been omitted for conciseness.

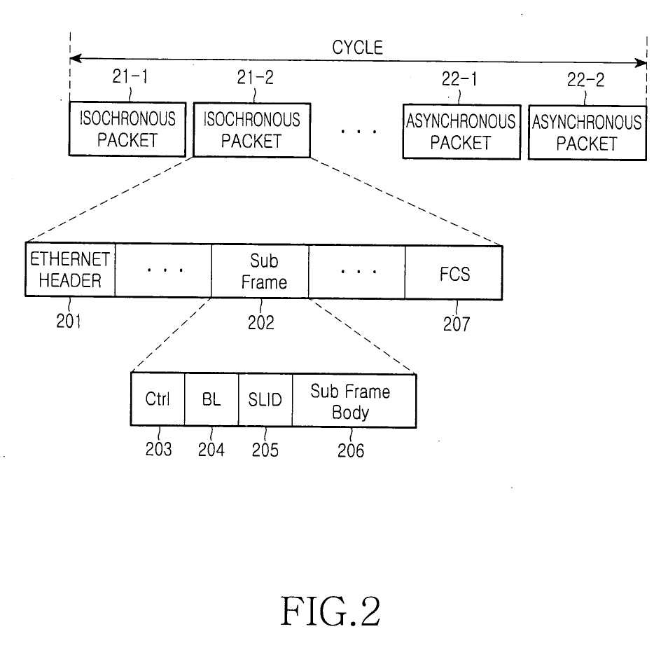

According to the present invention, a slot data-processed synchronous frame duration used in a conventional residential Ethernet is constructed by a plurality of isochronous packets, and data on a destination-by-destination basis is sub-frame-processed for the isochronous packet. A sub-frame-based super frame structure for a residential Ethernet according to an exemplary embodiment of the present invention is shown in FIG. 2.

FIG. 2 illustrates a transmission cycle in a residential Ethernet according to an exemplary embodiment of the present invention.

Referring to FIG. 2, the transmission cycle in the residential Ethernet (RE) according to the present invention is divided at its axis of time, as a cycle of interval of 125 μsec (a basic cycle for synchronous link) in consideration of synchronization. A plurality of isochronous packets 21-1 and 21-2 and a plurality of asynchronous packets 22-1 and 22-2 are provided in each cycle. The isochronous packets 21-1 and 21-2 are first transmitted and then the asynchronous packets 22-1 and 22-2 are transmitted. The asynchronous packet is the same in its format and processing as in a traditional legacy Ethernet and therefore, a disclosure thereof will be omitted in an exemplary embodiment of the present invention.

In a more detailed description of the isochronous packets 21-1 and 21-2, each isochronous packet is comprised of an Ethernet header 201 (including DA field for indicating destination address, SA field for indicating source address, and L field for indicating length information), and a sub-frame having a plurality of variable lengths within its sub-frame body surrounded by frame checksum sequence (FCS) 207.

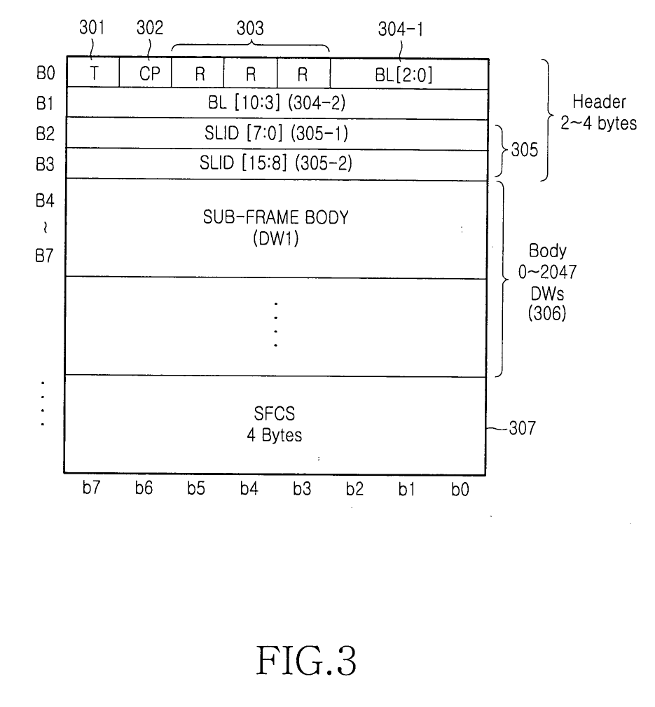

Each sub-frame includes a control (Ctrl) field 203, a body length field 204, a synchronous link identifier field 205, and a sub-frame body field 206. A detailed description thereof will be discussed with reference to FIG. 3.

FIG. 3 illustrates a sub-frame in the residential Ethernet according to an exemplary embodiment of the present invention.

Referring to FIG. 3, in the sub-frame in the residential Ethernet according to the present invention, a horizontal axis indicates bit number, and a vertical axis indicates a byte. The contents of the sub-frame are the control (Ctrl) field 203, a body length field 304, a synchronous link identifier field 305, and a sub-frame body field 306.

The control field 203 is includes, in one aspect of the invention, 5 bits (B0, b7 to b3). Two (2) bits (B0, b7 to b6) are used for sub frame type and cycle parity (CP), and the remaining 3 bits (B0, b5 to b3) are reserved for future use, for example.

The body length field 304 (BL) containing bit referred-to as B0, b2 to b0, and B1), indicates a body length of the sub-frame. The body length field utilizes a double word unit (DW, four bytes). The body length field 304 is required to limit a range of the subframe, and is required for other operations such as bandwidth calculation. The body length field 304 can be deleted in frame-based solution.

The body length field 304 is divided as two parts: one part (B0, b2 to b0) 304-1 represents a mandatory region and the other part (B1) 304-2 represents a selectively available region.

The synchronous link identifier field (SLID) 305 indicates that synchronous link to which the sub-frame belongs, and is used for sub-frame switching. All switching devices based on the synchronous link store switching records by synchronous link identifiers. The synchronous link identifier field 305 is essential to all sub-frame-based and frame-based solutions.

The “T” bit 301 in the control field 203 is used indicate whether the sub-frame is in synchronous data transmission. In an exemplary embodiment of the present invention, the “T” bit 301 is set to “0” to indicate synchronous data transmission. In other words, the “T” bit 301 is meant that all data are transferred using the sub-frame body 306 having a size of 0 to 2047DW. The sub-frame has a maximal length of 2047DW (or 8188 bytes). This length is longer than a maximal length of a conventional Ethernet frame. Thus, it is also applicable to jumbo Ethernet frame under discussion. However, if the jumbo Ethernet frame is not implemented, sub-frames having greater length can be segmented into a plurality of segments having identical sub-frame headers.

A case where the “T” bit 301 of the control field 203 is set to “1” indicates that synchronization control, management, and operation message is transferred using the sub-frame body.

The synchronization control, management, and operation message includes information of bandwidth reservation, synchronous switching table operation, device type detection, synchronous transmission control, media device control, and negotiation.

Such a synchronous control and management sub-frame (CMSF) is encapsulated within the isochronous packet for immediate response. Other operations (for example, acquirement of time synchronization and synchronous link identifier) that are not sensitive to time and are required prior to synchronous link configuration should be transmitted with the asynchronous packet. A detailed format of the CMSF is not described.

The “CP” bit 302 of the control field 203 is used to indicate whether the sub frame belongs to an odd or even cycle. In an exemplary embodiment of the present invention, the CP bit 302 is set to “0” to indicate and even cycle, while the CP bit 302 being set to “1” indicates an odd cycle. Thus, sub-frame stream sequentially received can be divided by the cycle (that is, the even or odd cycle). Further use of the CP bit will be later described.

The other 3 bits of the control field 203 are reserved as the reservation field 303 for future use.

An SFCS field 307 is used to check validity of the sub frame, and is used only for sub-frame basis. Operation is performed using algorithm such as Ethernet frame FCS field operation.

In the inventive residential Ethernet system, the field of the sub-frame header is described in Table 1 below.

TABLE 1

| Name | Byte.bit | Description |
|---|---|---|
| T | 0.7 | Sub-frame type. 0: Data. |
| | | 1: Control or Management. |
| CP | 0.6 | Cycle parity indicator. |
| | | 0: Belong to even cycle; 1: |
| | | Belong to odd cycle. |
| BL[10:0] | 1.7:0, 0.2:0 | Sub-frame body length in |
| | | unit of DW. Only used in |
| | | sub-frame based solution |
| SLID[15:0] | 3:2.7:0 | LSB 8-bit of synchronous |
| | | link identifier. |
| R | 0.5:3 | Reserved for future use. |

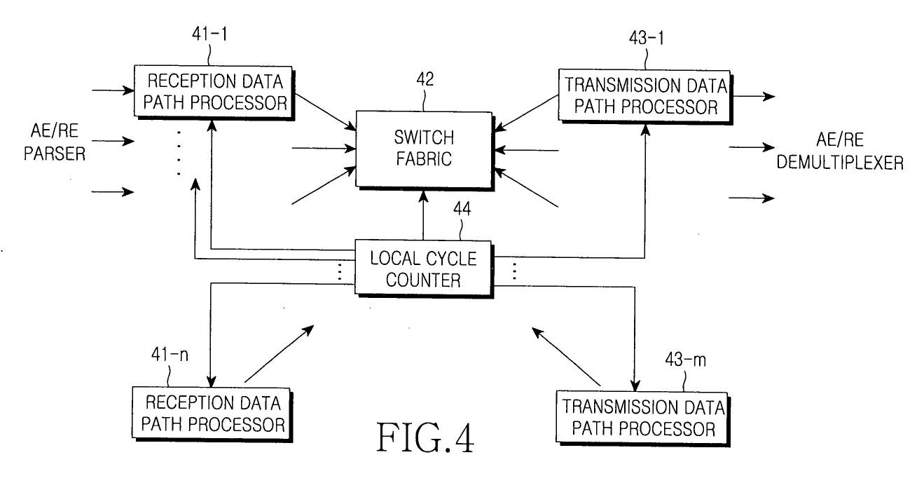

FIG. 4 illustrates a typical residential Ethernet switching device according to an exemplary embodiment of the present invention.

As shown in FIG. 4, the typical residential Ethernet switching device is almost the same in construction as a general legacy Ethernet switching device.

All residential Ethernet frames are parsed and inputted to the residential Ethernet switching device. As shown in FIG. 4, the residential Ethernet switching device needs three main modules for residential Ethernet switching. More specifically, the residential Ethernet switching device needs reception data path processors 41-1 to 41-n for receiving the residential Ethernet frames parsed as the sub-frames 1-n, respectively; a switch fabric 42 for switching the received residential Ethernet frames, and transmission data path processors 43-1 to 43-m for providing output path for multiplexing the switched residential Ethernet frames.

The reception data path processors 41-1 to 41-n, the switch fabric 42, and the transmission data path processors 43-1 to 43-m have the same construction not only in the residential Ethernet switching device but also in the legacy Ethernet switching device.

The present invention is characterized by further including a module for residential Ethernet switching operation, i.e. a local cycle counter 44.

After all nodes are time synchronized in the residential Ethernet, a time counter of each node is divided by 125 μs, thus becoming the local cycle counter 44. Thus, the local cycle counter 44 is thus synchronized to the network, and provides cycle start information and end information, and cycle numbering information.

In order to maintain timing for the residential Ethernet stream, all three main modules 41-1 to 41-n, 42, and 43-1 to 43-m acquire the cycle numbering information from the local cycle counter 44 and, according to priority based thereon, arrange cycle data streams different from each other.

In other words, each sub-frame can be given a priority using a cycle numbering value provided by the local cycle counter 44, thus satisfying a quality of service (QoS) of the Ethernet stream.

As described above, the inputted residential Ethernet streams are all fixed by a delay of two cycles, and are varied at a cycle of “0” to “2” by un-accumulated jitter. After transmission, the cycle parities and the two cycles are identically delayed and thus, it is possible to directly transmit all the sub- frames without any modification.

In an exemplary embodiment of the present invention, a description of the same general operation applied to the legacy Ethernet switching device and the residential Ethernet switching device will be omitted. Particular operation for the residential Ethernet data (that is, when T field is “0”) and a module thereof will now be described.

First, the reception data path processors 41-1 to 41-n will be described.

In reception data path processing in the residential Ethernet switching device according to an exemplary embodiment of the present invention, there are three significant points for timing control.

The first is that residential Ethernet data of adjacent cycle has an opposite CP bit. Thus, the CP bit is used to sequentially split the residential Ethernet stream inputted by a cycle based on the residential Ethernet data block. Accordingly, upon completion of processing of residential Ethernet data of an earlier cycle, residential Ethernet data of next cycle can be processed. Thus, a cycle sequence for the data processing is maintained.

The second is that a plurality of residential Ethernet sub-frames is combined into one residential Ethernet frame. In order to maintain the timing, the reception data path processor receives and immediately processes each sub-frame rather than receiving and processing whole residential Ethernet frame. The above SFCS field guarantees the combination of the sub-frames processed respectively.

The third is that since the transmission delay between two adjacent residential Ethernet nodes is small enough and ignored in comparison to a time of one cycle (125 μs), the cycle information of the received residential Ethernet sub frame can be restored using its CP bit and local cycle counter 44 and thus, the output cycle information can be set.

“Restored cycle information of sub frame+2 (“10” in binary number)” is the scheduled output cycle information. The two least significant bits (LSBs) of the output cycle information, are useful in considering the priority within the switching device according to the present invention. The output cycle information below is represented by the 2 LSBs.

Decision on the output cycle information depending on a local cycle number and the CP bit of the input sub frame is shown in Table 2.

TABLE 2

| | |
|---|---|
| Current cycle # | Output cycle # (b1:b0) |

| (b1:b0) | CP = 0 | CP = 1 |
|---|---|---|
| 00 | 10 | 01 |
| 01 | 10 | 11 |
| 10 | 00 | 11 |
| 11 | 00 | 01 |

In Table 2, when current cycle is “00”, the output cycle information is “10” and “01” depending on the CP bit of “0” and “1”, respectively. When the current cycle is “01”, the output cycle information is “10” and “11” depending on the CP bit of “0” and “1”, respectively. When the current cycle is “10”, the output cycle information is “00” and “11” depending on the CP bit of “0” and “1”, respectively. When the current cycle is “11”, the output cycle information is “00” and “01” depending on the CP bit of “0” and “1”, respectively.

The switch fabric 42 receives the sub-frames from all of the reception data path processors 41-1 to 41-n. Due to input jitter, the maximal three-cycle sub-frames can exist within the switch fabric 42 at the same time.

When current cycle number is “N”, three cycles of “N-2”, “N-1”, and “N” can be provided. The “N-2”-cycle sub-frame has the highest priority. The “N”-cycle sub frame has the lowest priority.

If there occurs collisions among the sub-frames, the priority level depending on the output cycle information is considered first, and all the sub frames having the highest priority should be switched primarily.

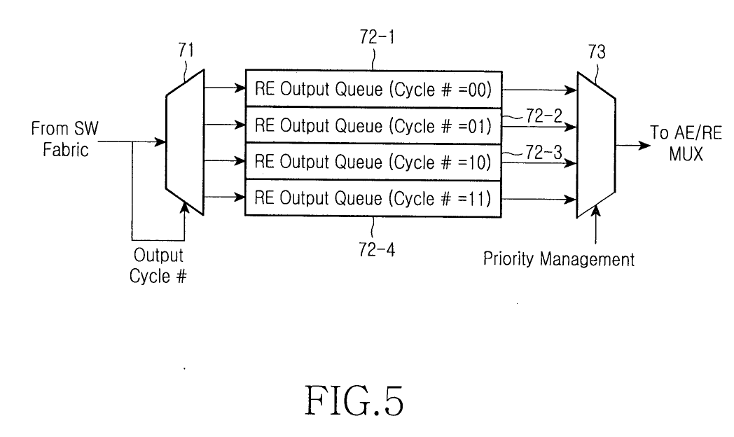

The transmission data path processors 43-1 to 43-m receive all of the switched sub frames from the switch fabric 42. A basic output design of the transmission data path processors 43-1 to 43-m are shown in FIG. 5.

FIG. 5 is a detailed view illustrating transmission data path processor in the residential Ethernet switching device according to the present invention.

As shown in FIG. 5, the inventive transmission data path processor includes a demultiplexer 71 for demultiplexing the sub-frames received from the switch fabric 42 depending on the output cycle information, four output queues 72-1 to 72-4 for storing each of the demultiplexed sub-frames depending on the output cycle information (00, 01, 10, and 11), and a multiplexer 73 for multiplexing the sub-frames received from the output queues 72-1 to 72-4, depending on the priority.

As such, each of the transmission data path processors 43-1 to 43-m has the four output queues 72-1 to 72-4 that are referenced by the cycle numbers of 2 LSBs (00, 01, 10, and 11). All switched and inputted sub -frames are recorded in each output queue depending on each scheduled output cycle information.

At cycle “N”, when output port is empty, cycle “N-1”-and output queue “N”-should be empty primarily. “N-1”-numbered queues have higher priority. Other two queues (N-2 and N-3) wait till their cycles. After almost expired queues are empty, an extra time of cycle is used for transmission of the asynchronous Ethernet frame, till next cycle.

At the output port, the sub-frames are recombined into the residential Ethernet frame. As more sub-frames are combined, an efficiency of the bandwidth improves. However, when transmission time almost expires, all possible sub-frames should be combined at the time point and immediately, transmitted together with suitable Ethernet frame header and FCS field. Possible extra sub frames should be combined in the next frame, and sequentially transmitted.

In the present invention, the sub frame-based residential Ethernet solution guarantees the timing by providing a method for controlling the timing in the residential Ethernet switching device.

Further, in the present invention, the operation of the sub-frame based residential Ethernet switching device can be simply scheduled by using the added CP bit and local cycle number information.

While the invention has been shown and described with reference to a certain preferred embodiment thereof, it will be understood by those skilled in the art that various changes in form and details may be made therein without departing from the spirit and scope of the invention as defined by the appended claims.

What is claimed is:

1. A residential Ethernet switching device for sub-frame-based switching in a residential Ethernet system distinguishing and transmitting isochronous data and asynchronous data, the device comprising:
a plurality of reception data path processors for parsing a residential Ethernet frame inputted to the residential Ethernet switching device, as respective residential Ethernet sub-frames, and outputting the parsed residential Ethernet sub frames;
a switch fabric for switching the residential Ethernet sub-frames inputted through the plurality of reception data path processors;
a plurality of transmission data path processors for outputting the residential Ethernet sub frames switched through the switch fabric; and
a local cycle counter connected to the plurality of reception data path processors, the switch fabric, and the plurality of transmission data path processors, and providing cycle counter information on the respective residential Ethernet sub frames.

2. The residential Ethernet switching device of claim 1, wherein each of the plurality of residential Ethernet sub-frames comprises:
a control field for providing cycle parity information on the residential Ethernet sub-frame and information on a residential Ethernet sub-frame type;
a body length field for indicating a body length of the residential Ethernet sub-frame;
a synchronous link identifier field for indicating the number of synchronous links to which the residential Ethernet sub frame belongs; and
a residential Ethernet sub-frame body field containing data to transmit.

3. The residential Ethernet switching device of claim 2, wherein the control field comprises:
a CP (cycle parity) field for indicating whether the residential Ethernet sub-frame represents an odd cycle or an even cycle; and
a T bit field for indicating whether the data transmitted through residential Ethernet sub-frame body is isochronous data, or message data for synchronization control, management, and operation.

4. The residential Ethernet switching device of claim 3, wherein the reception data path processor sets the CP bit in adjacent cycles of the inputted residential Ethernet sub-frame to have alternate polarity.

5. The residential Ethernet switching device of claim 4, wherein the reception data path processor determines scheduled output cycle information of the inputted residential Ethernet sub-frame, using CP bit and local cycle counter value thereof.

6. The residential Ethernet switching device of claim 5, wherein the output cycle information is expressed with 2 LSBs (least significant bit).

7. The residential Ethernet switching device of claim 6, wherein the switch fabric can allow maximal three-cycle sub frames at the same time, for the sub frames received from the plurality of reception data path processors wherein a current output cycle information is denoted by “N”, and has lowest priority.

8. The residential Ethernet switching device of claim 7, wherein each of the plurality of transmission data path processor comprises:
a demultiplexer for demultiplexing the residential Ethernet sub-frames received from the switch fabric, depending on an output cycle number thereof;
four output queues for storing each of the demultiplexed residential Ethernet sub frames depending on output cycle information thereof; and
a multiplexer for multiplexing the residential Ethernet sub frames from the four output queues, depending on priority.

9. The residential Ethernet switching device of claim 8, wherein the four output queues are referenced based on the 2 LSBs of the respective residential Ethernet sub-frames, and store associated the residential Ethernet sub frame based on their 2 LSBs values.
